(19) United States
(12) Patent Application Publication
(10) Pub. No.: US 2009/0146517 A1
(43) Pub. Date: Jun. 11, 2009

(54) Rotor for an electric synchronous machine

(75) Inventor: Roger Tresch, Mohlin (CH)

Correspondence Address: KAGAN BINDER, PLLC, SUITE 200, MAPLE ISLAND BUILDING, 221 MAIN STREET NORTH, STILLWATER, MN, 55082, US

(73) Assignee: e+a Elektromaschinen und Antriebe AG

(21) Appl. No.: 12/315,446

(22) Filed: Dec. 3, 2008

(30) Foreign Application Priority Data
Dec. 5, 2007 (EP) 07122419.0

(51) Int. Cl. H02K 21/16

(52) U.S. Cl. 310/156.28

(57) ABSTRACT

The present invention relates to a rotor for an electric synchronous machine, which has at its outside at least one magnetic material area 10 surrounded by a wrapping 11, said magnetic material area 10 having an non-round outer contour.

The present invention relates to a rotor for an electric synchronous machine, in particular a synchronous machine excited by a permanent magnet.

It is known to provide rotors for electric synchronous machines in the form of a sleeve or shell bearing permanent magnets on its outer shell surface. These magnets are retained by a shell or wrapping. For example, the wrapping is pressed onto the magnets so that it rests on the magnet under pretension to prevent a potentially occurring gap also in operation.

To prevent, especially in the case of high rotational speeds, temperature-induced expansions and the formation of gaps by detachment of the magnets through radial forces it has also been suggested to provide a conical design of the inner shell of the rotor. This has the effect that when the rotor is pressed onto the shaft, the shaft will generate a pretension from within. This is for example shown in document EP-A-0 631 364.

The object underlying the invention is to provide a rotor for a synchronous machine, which prevents detachment of the magnets at high rotational speeds thereby further improving operability at high rotational speeds.

This object is achieved by the claims.

The basic idea underlying the present invention is to impart, in a rotor for an electric synchronous machine which rotor has at the outside at least one magnetic material area surrounded by a wrapping, a non-round outer contour to the magnetic material area. As will be explained in more detail below, such a design is connected with advantages regarding mechanical strength and with an improved (more sinus-shaped) flow curve.

The term “non-round” as used herein comprises any shape of an outer contour not having a radius starting at the center of rotation of the rotor, i.e. at its rotational axis. In particular, eccentric in relation to the center of rotation of the rotor and its rotational axis, respectively, circle shaped outer contours, elliptic outer contours and clothoidic outer contours are included. Such outer contours allow that at the gap between the individual poles of the magnetic material area, i.e. at the pole gaps, no bends are present in the outer edge. According to a preferred embodiment of the present invention, a tangential transition is present in these areas.

Preferably, the outer contour of the magnetic material area consists of a plurality of circle segments, the centers of the respective circles being offset relative to the rotor axis or the “center” of the rotor. Preferably, this offset or displacement corresponds to the thickness of the magnetic material area. It is also preferred that said circle segments have the same radius. This means that the circle centers of the individual circle segments lie on one circle around the rotor axis, the radius of which corresponds to the thickness of the magnetic material area.

The wrapping surrounding the magnetic material area preferably has a corresponding non-round inner contour. The wrapping is preferably made from a fiber-reinforced plastic material. In this case, the wrapping can already be produced with a corresponding non-round or non-concentric inner contour and superimposed onto the magnetic material area. Alternatively, the wrapping may be made from metal. In the pressed on state, such a metal shell adapts to the non-round outer contour of the magnetic material area.

Independently of the material used, the wrapping is preferably pressed onto the magnetic material area to thus achieve a corresponding pretension. Alternatively, the wrapping is superimposed onto the magnetic material area without pretension, i.e. with corresponding play, and then, e.g., sealed with casting resin in order to fill in the existing gap.

Preferably, the rotor of the invention further contains a copper layer between the outer surface of the sleeve-shaped rotor and the inner surface of the magnetic material area. This is of advantage, since in case of the corresponding pretension and due to the radially acting forces, respectively, the copper layer acts as buffer element owing to the softness and the easy deformability of its material. This is particularly advantageous in case of carbon fiber wrappings. In case of carbon fiber wrappings, the pretension increases during operation, since the metal expands due to an increase in temperature and the radial forces exerted, while in contrast the carbon fiber wrapping shrinks in view of the negative temperature coefficient and the low modulus of elasticity. Such opposite movements or expansions are muted or cushioned by the copper layer. This is associated with significantly improved mechanical strength.

The rotor of the present invention preferably has a conically shaped rotor hole in order to produce a pretension from within when the rotor is pressed onto the shaft. Such a conical rotor hole is, moreover, of advantage since the degree of pretension can be determined or adjusted by the extent to which the rotor is slid onto the shaft.

Preferably there is hydraulic support for sliding the rotor onto the shaft so that a slight oil film is present between the shaft and the rotor cone.

The present invention is described in detail with reference to the attached drawings. In the drawings:

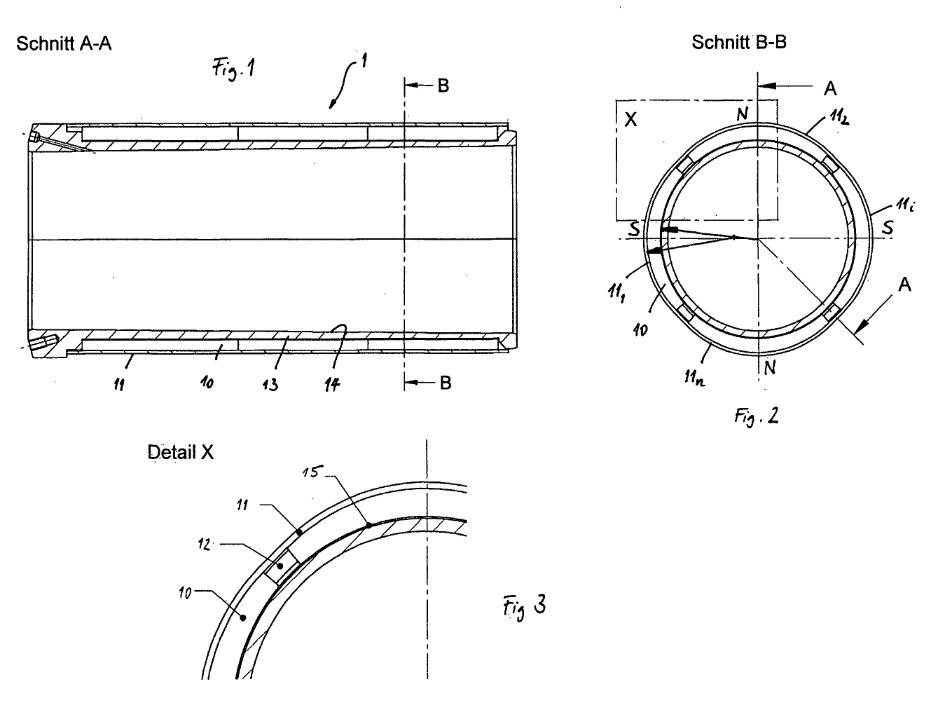

FIG. 1 is a longitudinal sectional view of the rotor of the present invention;

FIG. 2 is a sectional view through the rotor of the invention along line B-B; and

FIG. 3 is an enlarged detail view of the cross section of FIG. 2.

FIG. 1 shows the inventive rotor 1 in a cross sectional view A-A. The magnetic material area 10 is formed at the outer shell surface of the rotor sleeve 13. A wrapping 11 which surrounds the magnets is pressed onto the magnetic material area 10 (e.g. permanent magnets). FIG. 1 clearly shows the conical inner surface 14 of the rotor sleeve 13.

The sectional view B-B of FIG. 2 shows the alternating magnet poles superimposed onto the rotor 1. Both FIGS. 2 and 3 show the non-round outer contour of the magnetic material area 10. The superimposed wrapping 11 also shows this non-round contour. The individual segments 11₁, 11₂, . . . , 11ᵢ, . . . , 11ₙ, and the outer surface of the magnetic material area, respectively, have a radius, the center of which is off center from the rotor axis. To illustrate this, FIG. 2 shows the radius of the outer contour of the rotor sleeve 13 on the one hand, and, by way of example, also a radius of the segment 11₁. The radius or the radii, respectively, of the circle segments are selected in such a way that a tangential transition from one segment to the next is present in the respective pole gaps. This can clearly be seen in FIG. 3 on the example of pole gap 12.

FIG. 3 further shows the optional copper sheet 15 which may be provided between the rotor shell outer surface and the inner surface of the magnetic material area. Alternatively, or additionally, a copper sheet (not shown in FIG. 3) may be provided between the outer surface of the magnetic material area and the wrapping.

We claim:

1. A rotor for an electric synchronous machine, at the outside of which at least one magnetic material area is present, said area being surrounded by a wrapping, characterized in that the magnetic material area has a non-round outer contour.

2. A rotor according to claim 1, wherein the outer contour consists of a plurality of circle segments, the centers of which circles are offset relative to the rotor axis.

3. A rotor according to claim 2, wherein the plurality of circle segments have the same radius.

4. A rotor according to claim 2, wherein the displacement of the centers of the circles relative to the rotor axis correspond to the radial thickness of the magnetic material area.

5. A rotor according to claim 1, wherein the non-round outer contour is arranged such that a tangential transition is present in the area of the pole gaps of the magnetic material area.

6. A rotor according to claim 1, wherein the wrapping has a non-round inner contour which corresponds to the non-round outer contour of the magnetic material area.

7. A rotor according to claim 1, wherein the wrapping is made from fiber-reinforced plastic material.

8. A rotor according to claim 1, wherein the wrapping is made from metal.

9. A rotor according to claim 1, wherein the wrapping is pressed onto the magnetic material area.

10. A rotor according to claim 1, wherein the wrapping is superimposed without pretension onto the magnetic material area and sealed therewith.

11. A rotor according to claim 10, wherein the wrapping is sealed with a thermo-conductive casting resin.

12. A rotor according to claim 1, wherein the rotor is sleeve shaped.

13. A rotor according to claim 12, wherein additionally, at least in part, a copper layer is provided between the outer surface of the sleeve and the inner surface of the magnetic material area.

14. A rotor according to claim 1, wherein the rotor hole is conically shaped.

15. A rotor according to claim 1, wherein the magnetic material area is made from permanent magnets.
